(19) United States
(12) Patent Application Publication
(10) Pub. No.: US 2024/0426972 A1
(43) Pub. Date: Dec. 26, 2024

(54) NETWORK ENTITY AND METHOD FOR COOPERATIVE MONO-STATIC RADIO FREQUENCY SENSING IN CELLULAR NETWORK

(71) Applicant: QUALCOMM INCORPORATED, San Diego, CA (US)

(72) Inventors: Weimin DUAN, San Diego, CA (US); Alexandros MANOLAKOS, Athens (GR); Krishna Kiran MUKKAVILLI, San Diego, CA (US)

(21) Appl. No.: 18/701,850

(22) PCT Filed: Dec. 5, 2022
(86) PCT No.: PCT/US2022/080909

§ 371 Date: Apr. 16, 2024

(30) Foreign Application Priority Data
Dec. 30, 2021 (GR) 20210100922

(51) Int. Cl. G01S 7/02; G01S 7/00; G01S 13/66

(52) U.S. Cl. CPC G01S 7/0232; G01S 7/006; G01S 13/66

(57) ABSTRACT

A mono-static radio frequency sensing coordination method includes: determining, by a network entity for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and transmitting, from the network entity to the first apparatus, a first configuration message indicating for the first apparatus to use the first configuration of the first cellular network signal for monostatic radio frequency sensing.

### CROSS-REFERENCE TO RELATED APPLICATIONS

This application claims the benefit of Greek patent application Ser. No. 20210100922, filed Dec. 30, 2021, entitled “COOPERATIVE MONO-STATIC RADIO FREQUENCY SENSING IN CELLULAR NETWORK,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example network entity includes: a memory; a transceiver; and a processor, communicatively coupled to the memory and the transceiver, configured to: determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and transmit, to the first apparatus, a first configuration message indicating for the first apparatus to use the first configuration of the first cellular network signal for mono-static radio frequency sensing.

An example mono-static radio frequency sensing coordination method includes: determining, by a network entity for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and transmitting, from the network entity to the first apparatus, a first configuration message indicating for the first apparatus to use the first configuration of the first cellular network signal for mono-static radio frequency sensing.

Another example network entity includes: means for determining, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and means for transmitting, to the first apparatus, a first configuration message indicating for the first apparatus to use the first configuration of the first cellular network signal for mono-static radio frequency sensing.

An example non-transitory, processor-readable storage medium includes processor-readable instructions to cause a processor of a network entity to: determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and transmit, to the first apparatus, a first configuration message indicating for the first apparatus to use the first configuration of the first cellular network signal for mono-static radio frequency sensing.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a simplified block diagram of an example sensing apparatus.

FIG. 6 is a simplified block diagram of an example network entity.

FIG. 7 is a simplified diagram of an environment for radio frequency sensing.

FIG. 8 is a timing diagram of a signaling and process flow for coordinated mono-static radio frequency sensing.

FIG. 9 is an example of a radio frequency sensing request.

FIG. 10 is an example of a capability message.

FIG. 11 is an example of an assistance data message.

FIG. 12 is an example of a measurement/parameter report.

FIG. 13 is an example of a parameter report.

FIG. 14 is a block flow diagram of a mono-static radio frequency sensing coordination method.

### DETAILED DESCRIPTION

Techniques are discussed herein for coordinated mono-static radio frequency sensing. For example, a sensing apparatus (e.g., a user equipment or a base station) can perform mono-static radio frequency sensing in a cellular network and a network entity (e.g., a base station or a server) can coordinate the mono-static radio frequency sensing by the sensing apparatus, e.g., to help avoid interference with a sensing signal for the mono-static radio frequency sensing. The network entity can coordinate cellular network signal transmission by the sensing apparatus and one or more other transmitters (e.g., another sensing apparatus, a base station, etc.) to help ensure good performance of the mono-static radio frequency sensing, e.g., accurate measurements. The network entity may use one or more requested signal configuration characteristics, one or more sensing apparatus capabilities, one or more sensing signal measurements, and/or one or more object parameter values to determine one or more sensing signal configurations and/or one or more sensing instructions. The network entity may coordinate multiple sensing apparatus, e.g., to selectively track one or more respective target objects by each of the sensing apparatus, to perform mono-static radio frequency sensing for different coverage areas (e.g., to help avoid duplicative object tracking), etc. The network entity may provide the sensing apparatus with reference information that the sensing apparatus may use to help ensure good measurement accuracy, e.g., to avoid or reduce interference with a sensing signal. These techniques are examples, and other implementations of techniques for coordinated mono-static radio frequency sensing may also or alternatively be used.

Items and/or techniques described herein may provide one or more of the following capabilities, as well as other capabilities not mentioned. Measurement accuracy of mono-static radio frequency sensing in a cellular network may be improved (e.g., by reducing sensing signal interference). Objects may be efficiently tracked by mono-static radio frequency sensing in a cellular network, e.g., by assigning different regions for different sensing apparatus to cover and/or assigning different objects to different sensing apparatus for tracking. Radio frequency interference may be managed resulting in enhanced sensing performance and/or efficiency. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

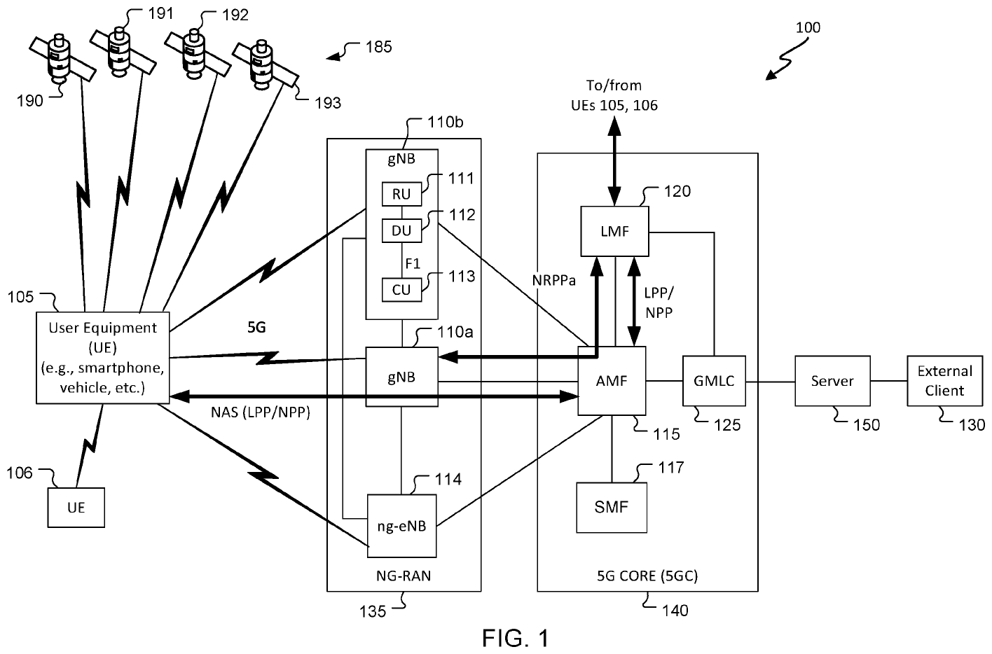

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything. e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

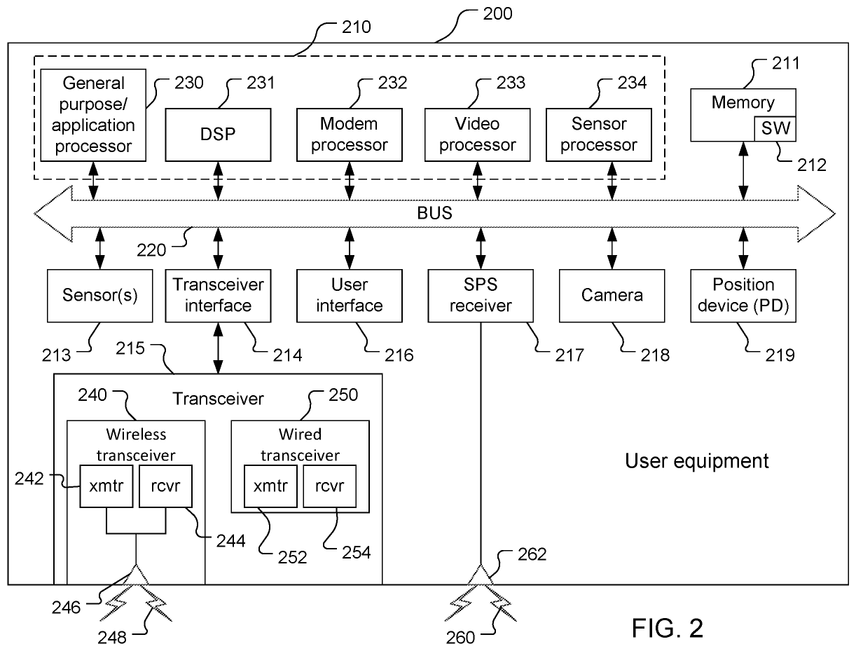

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

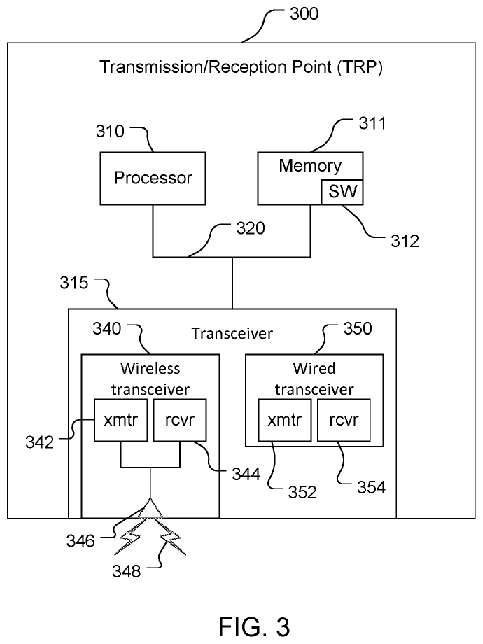

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

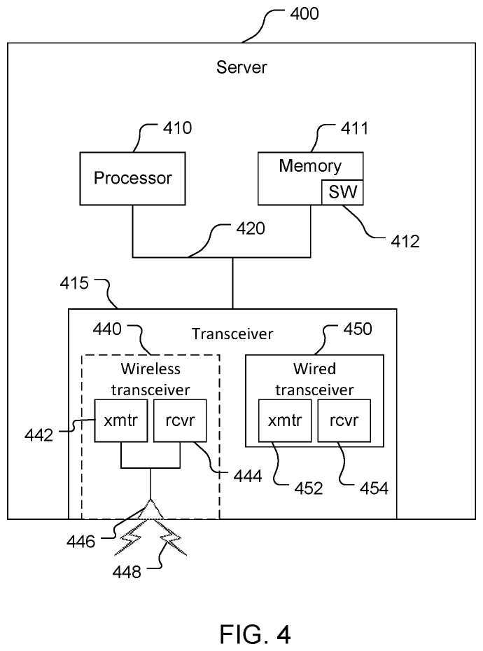

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Radio Frequency Sensing

Radio frequency sensing (RF sensing) is a technique for sensing the presence and/or movement of one or more objects in an environment based, at least in part, on the transmission and reception of electromagnetic signals. RF sensing uses infrastructure (e.g., a base station and/or a UE) and time and frequency resources of a cellular communication system to measure an environment of a transmitting device and a receiving device to detect object presence and/or motion. Changes in the environment can be detected based on changes in a wireless communication channel between the transmitting device and the receiving device. For example, the presence or movement of the object(s) in the environment may interfere with or otherwise alter the phase or amplitude of a reference signal (e.g., a dedicated reference signal such as a CSI-RS and/or a dual-function reference signal such as a wireless communication signal) transmitted from the transmitting device, reflected by the object(s), and received by the receiving device, and thus, the wireless channel. The range of applications and/or accuracy of RF sending may depend on an amount and/or detail of information communicated between the transmitting device and the receiving device. A mono-static RF sensing apparatus serves as both the transmitting device and the receiving device. Mono-static RF sensing provides flexibility by not requiring cross-node cooperation for transmission and reception of a reference signal. Mono-static RF sensing may, however, be enhanced by having cross-node cooperation, e.g., coordinated by a control device. Mono-static RF sensing may be coordinated based on one or more of a variety of factors, e.g., interference reduction, object tracking, measurement accuracy, etc.

Techniques are discussed herein for using cellular communication systems (e.g., 5G and beyond) for coordinated mono-static RF sensing. Large bandwidths provided for such cellular communications systems may allow such cellular communication systems to provide accurate RF sensing services. Upper layer (e.g., MAC layer and above) procedures for positioning (e.g., NR UE positioning) may be reused or modified (e.g., enhanced) for providing RF sensing service. Various reference signals, such as PRS, may be used for RF sensing, e.g., due to the large bandwidth of PRS in the physical layer (PHY). For example, in FR1 (450 MHz-6 GHz (sub-6 GHz range)), PRS may have a bandwidth of 100 MHz, in FR2 (24.25 GHz-52.6 GHz (mm-wave)), PRS may have a bandwidth of 400 MHz, and for FR3 (10 GHz-20 GHz, e.g., 13 GHz), PRS may have a bandwidth of 200 MHz. In terahertz (THz) signaling, PRS may have a bandwidth of 1 GHz or more (e.g., for short-range (e.g., several meters) RF sensing). Also, carrier aggregation may be used to increase the bandwidth of the PRS. Reference signals other than PRS may be used. For example, communication signals may be used as reference signals, thus serving dual purposes.

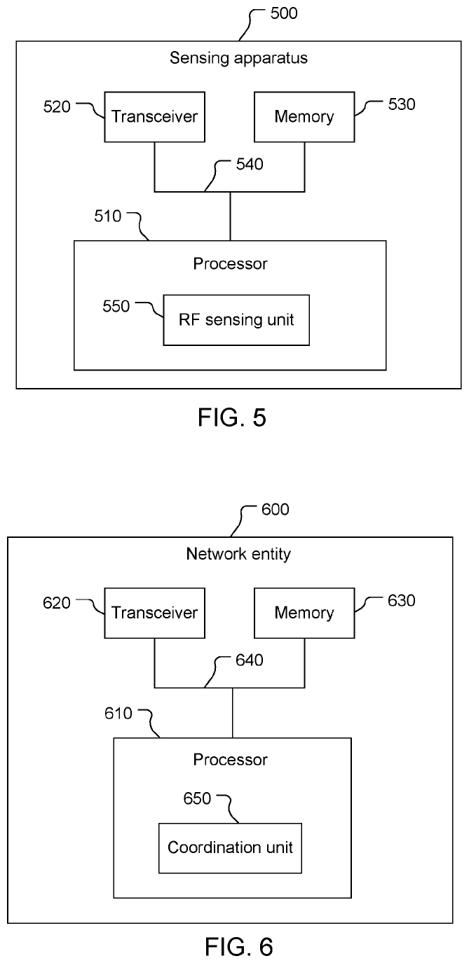

Referring also to FIG. 5, a sensing apparatus 500 includes a processor 510, a transceiver 520, and a memory 530 communicatively coupled to each other by a bus 540. The sensing apparatus 500 may include the components shown in FIG. 5. The sensing apparatus 500 may be, for example, a UE or a base station (e.g., a gNB). For example, the sensing apparatus 500 may include one or more other components such as any of those shown in FIG. 2 such that the UE 200 may be an example of the sensing apparatus 500, and/or any of the components shown in FIG. 3 such that the TRP 300 may be an example of the sensing apparatus 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. As another example, the processor 510 may include one or more of the components of the processor 310, the transceiver 520 may include one or more of the components of the transceiver 315, and the memory 530 may be configured similarly to the memory 311, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the sensing apparatus 500 performing a function as shorthand for one or more appropriate components (e.g., the processor 510 and the memory 530) of the sensing apparatus 500 performing the function. The processor 510 (possibly in conjunction with the memory 530 and, as appropriate, the transceiver 520) may include an RF sensing unit 550 (radio frequency sensing unit). The RF sensing unit 550 is discussed further below, and the description may refer to the processor 510 generally, or the sensing apparatus 500 generally, as performing any of the functions of the RF sensing unit 550. The sensing apparatus 500 is configured to perform the functions of the RF sensing unit 550 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions. The network entity 600 may be, for example, a TRP that coordinates multiple UE mono-static sensing apparatus or a server that coordinates multiple mono-static sensing apparatus where at least one of the sensing apparatus is a TRP. The network entity 600 may also be a sensing apparatus, e.g., a base station that acts as a sensing apparatus and coordinates RF sensing by the network entity 600 and at least one other sensing apparatus (e.g., one or more UEs).

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include coordination unit 650. The coordination unit 650 is discussed further below, and the description may refer to the processor 610 generally, or the network entity 600 generally, as performing any of the functions of the coordination unit 650. The network entity 600 is configured to perform the functions of the coordination unit 650.

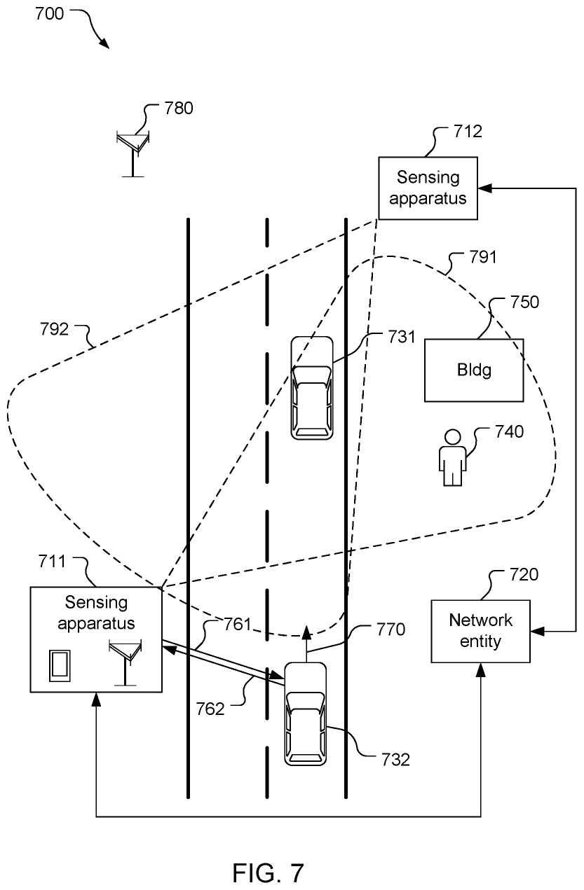

Referring also to FIG. 7, examples of the sensing apparatus 500 and the network entity 600 may be part of an environment 700 for coordinated mono-static RF sensing. For example, the environment 700 includes a sensing apparatus 711, a sensing apparatus 712, and a network entity 720 that are examples of the sensing apparatus 500 and the network entity 600, respectively. The network entity 720 communicates with the sensing apparatus 711, 712 bi-directionally to coordinate mono-static RF sensing by the sensing apparatus 711, 712. The network entity 720 may be hard-wired to one or more of the sensing apparatus 711, 712, e.g., if the network entity 720 is a server and the sensing apparatus 711 is a TRP. The network entity 720 may communicate with one or more of the sensing apparatus 711, 712 through wireless communication, e.g., if the network entity 720 is a TRP and the sensing apparatus 711 is a UE. The environment 700 may include one or more other devices, e.g., a base station 780, that can transmit and/or receive wireless signals (e.g., communication signals, reference signals, etc.). The other device(s) may or may not be configured to perform RF sensing, and if configured to perform RF sensing, may not perform RF sensing (at all or at a given time).

The sensing apparatus 711, 712 may each transmit and receive radio frequency RS (Reference Signal(s)) in order to perform mono-static RF sensing, e.g., to detect presence of, and possibly one or more parameters associated with, one or more objects such as a vehicle 731, a vehicle 732, a person 740, a building 750. For example, the sensing apparatus 711 transmits a reference signal 761 that reflects off the vehicle 732 to produce a reflected signal 762, and the sensing apparatus 711 receives the reflected signal 762. The reflected signal 762 may be measured to obtain one or more RS measurements and the measurement(s) may be used to determine presence of the vehicle 732 and possibly one or more parameters based on the RS measurement(s), e.g., based on timing, magnitude, and direction of the received signal. The one or more parameters may include, for example, a range from the sensing apparatus 711 to the vehicle 732, an angle from the sensing apparatus 711 to the vehicle 732, direction of motion of the vehicle 732, and/or speed of the vehicle 732, etc. For example, a direction 770 of the vehicle 732 may be determined relative to a global direction reference coordinate system (e.g., north/east). The presence of stationary, persistent objects such as a building 750 may be determined and ignored, or may be used to determine motion of a sensing apparatus, used to determine location of a moving object relative to a stationary object, and/or used for one or more other purposes.

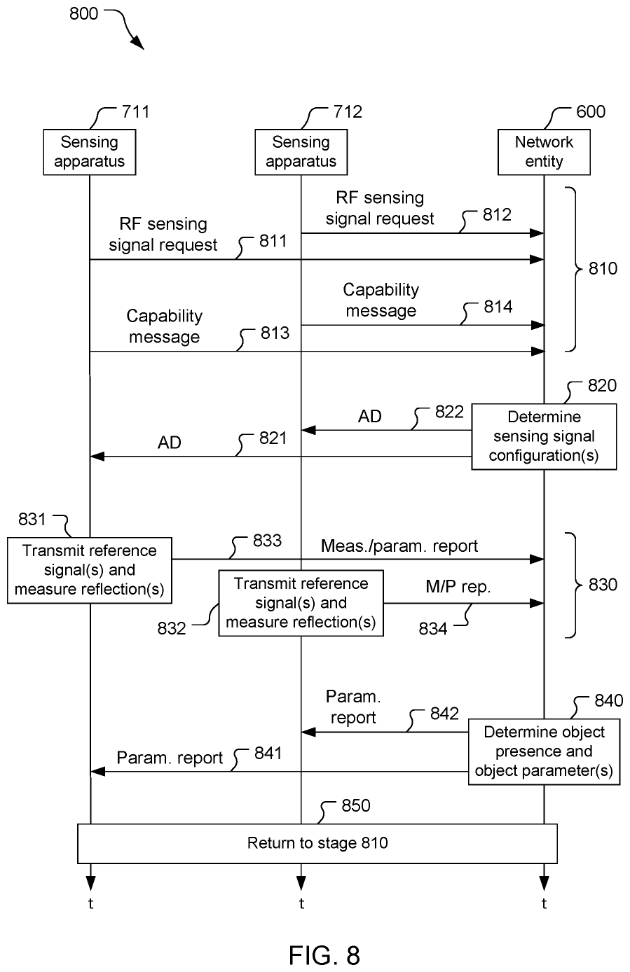

Referring also to FIG. 8, a timing diagram shows a signaling and process flow 800, for coordinated mono-static RF sensing, that includes the stage shown. The flow 800 is an example and other flows are possible, e.g., with one or more stages shown omitted, one or more stages added, and/or one or more stages shown altered. For example, stage 810 may be omitted, or may be performed between a first performance of stage 820 and a second performance of stage 820. As another example variation of the flow 800, stage 810, or an altered version of stage 810, may be repeated, e.g., performed before a first performance of stage 820 and performed between the first performance of stage 820 and a second performance of stage 820. As another example, stage 820 may first be performed after stage 830. As another example, stage 830 may be omitted, or may be performed between a first performance of stage 820 and a second performance of stage 820. As another example, stage 830, or an altered version of stage 830, may be repeated, e.g., performed before a first performance of stage 820 and performed between the first performance of stage 820 and a second performance of stage 820. As another example, stage 840 may be omitted, e.g., if the sensing apparatus 711, 712 do not report RF sensing measurement(s), e.g., for local-based mono-static RF sensing. In local-based mono-static RF sensing, the sensing apparatus may not report reference signal measurement(s), or one or more parameters determined from the reference signal measurement(s), to the network entity 600. In network-based mono-static RF sensing, the sensing apparatus report reference signal measurement(s) to the network entity 600 and the network entity 600 conducts object detection and/or parameter estimation (e.g., range to object, direction of motion of object, speed of object, etc.). As another example, stage 820 may be repeated one or more times, with stage 810 and/or stage 830 performed between performances of stage 820. Still other variations of the flow 800 may be implemented. While the discussion of the flow 800 discusses configuring a reference signal for the sensing apparatus and a reference signal for the sensing apparatus 712, more than one reference signal could be configured for the sensing apparatus 711 and/or the sensing apparatus 712.

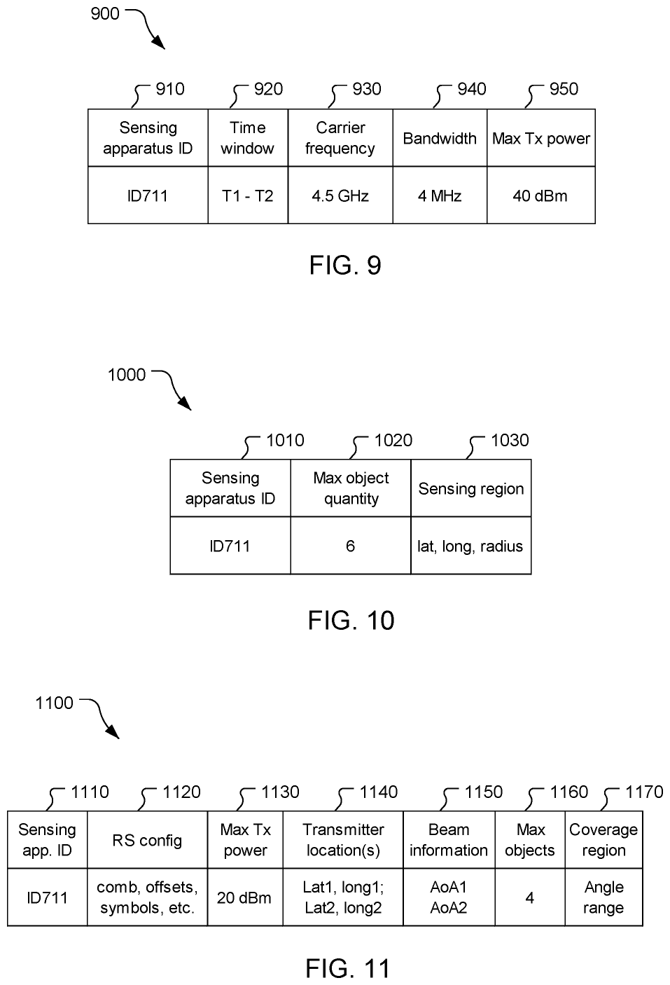

At stage 810, an RF sensing signal request 811 may be transmitted by the sensing apparatus 711 (e.g., the RF sensing unit 550 of the sensing apparatus 711) to the network entity 600 and/or an RF sensing signal request 812 may be transmitted by the sensing apparatus 712 (e.g., the RF sensing unit 550 of the sensing apparatus 712) to the network entity 600. The RF sensing signal requests 811, 812 may each indicate, to the network entity 600, one or more desired factors for reference signal transmission by the sensing apparatus 711, 712, respectively, for RF sensing. For example, referring also to FIG. 9, an RF sensing signal request 900, which is an example of the RF sensing signal request 811, includes a sensing apparatus ID field 910, a time window field 920, a carrier frequency field 930, a bandwidth field 940, and a maximum transmission power field 950. One or more of the fields 920, 930, 940, 950 may be omitted from other examples of the RF sensing signal request 811. The sensing apparatus ID field 910 provides in identifier of the sensing apparatus 711 (in this example, “ID711”). The time window field 920 indicates a desired time window for the sensing apparatus 711 to transmit a reference signal for RF sensing. The carrier frequency field 930 indicates a desired carrier frequency for the reference signal. The bandwidth field 940 indicates a desired bandwidth of the reference signal. The maximum transmission power field 950 indicates a desired maximum transmit power for the reference signal. The maximum transmission power field 950 may be omitted from the RF sensing signal request 900, e.g., if the maximum transmit power is statically configured (e.g., during manufacture) in accordance with an industry standard. One or more other desired features corresponding to a reference signal for RF sensing may be conveyed to the network entity 600 in the RF sensing signal request 811 and/or the RF sensing signal request 812. The factor(s) indicated by the RF sensing signal request 811 and/or the RF sensing signal request 812 may be explicitly or implicitly indicated. For example, an RF sensing signal request may indicate (e.g., as part of the sensing apparatus ID field 910) a model of a corresponding sensing apparatus and the model may correspond to a desired maximum transmit power for a reference signal for RF sensing.

Also or alternatively at stage 810, the sensing apparatus 711 may transmit a capability message 813 to the network entity and/or the sensing apparatus 712 may transmit a capability message 814 to the network entity 600. The capability messages 813, 814 may each indicate one or more RF sensing capabilities of the sensing apparatus 711, 712, respectively. For example, referring also to FIG. 10, a capability message 1000, which is an example of the capability message 813, includes a sensing apparatus ID field 1010, a maximum object quantity field 1020, and a sensing region field 1030. The maximum object quantity field 1020 indicates a maximum quantity of different objects that the sensing apparatus 711 is capable of detecting or tracking concurrently using RF sensing. The sensing region field 1030 indicates a region over which the sensing apparatus 711 may measure reflections of reference signals for RF sensing. The sensing region field 1030 may contain, as in this example, a location of the sensing apparatus 711 (in this example, expressed as a latitude value and a longitude value) and a radius of a circular region centered at the location of the sensing apparatus 711 to define the region. The sensing region field 1030 may indicate multiple sub-regions, e.g., sectors of a circular coverage region (e.g., corresponding to different antenna beams of the sensing apparatus 711). The capability message 813 and/or the capability message 814 may indicate one or more capabilities implicitly. For example, the capability message 1000 may indicate (e.g., as part of the sensing apparatus ID field 1010) a model of a corresponding sensing apparatus and the model may correspond to a maximum quantity of objects that may be tracked by the sensing apparatus 711.

At stage 820, the network entity 600 (e.g., the coordination unit 650) determines assistance data (e.g., one or more sensing signal configurations and/or one or more instructions and/or reference information) for the sensing apparatus 711, 712. The network entity 600 may use one or more of the factor(s) indicated by one or more of the RF sensing signal requests 811, 812 and/or one or more of the capabilities indicated by one or more of the capability messages 813, 814 to determine a reference signal configuration for the sensing apparatus 711 and/or a reference signal configuration for the sensing apparatus 712, and/or to determine one or more instructions (e.g., regarding objects to track or a sub-region to monitor) for the sensing apparatus 711 and/or the sensing apparatus 712. Also or alternatively, the network entity 600 may consider one or more other factors independent of the RF sensing signal requests 811, 812 and the capability messages 813, 814, e.g., stored in the memory 630, to determine the reference signal configuration for the sensing apparatus 711 and/or the reference signal configuration for the sensing apparatus 712, and/or to determine the one or more instructions for the sensing apparatus 711 and/or the sensing apparatus 712. The network entity 600 may try to determine the reference signal configurations for the sensing apparatus 711, 712 such that the reference signal configurations meet the desired values of the factor(s) in the RF sensing signal requests 811, 812 and such that the reference signals will have acceptably low interference. For example, the network entity 600 may determine the reference signal configuration for the sensing apparatus 711 such that the reference signal will be transmitted at a different time and/or with a different frequency than another signal that is transmitted by the sensing apparatus 712 or another apparatus (e.g., the base station 780). That is, the network entity 600 may determine the RS configuration for RF sensing for the sensing apparatus 711 such that the RS will be TDMed (time division multiplexed) and/or FDMed (frequency division multiplexed) with another signal that may cause unacceptable interference with the reference signal (e.g., cause an SNR (signal-to-noise ratio) for the reference signal to be unacceptably low). The network entity 600 may thus determine the RS configuration for the sensing apparatus 711 in conjunction with the RS configuration for the sensing apparatus 712 and/or in conjunction with the configuration of any other signal from the sensing apparatus 712 or another transmitter that might unacceptably interfere with the RS signal of the sensing apparatus 711. The network entity 600 may also determine the configuration of the other signal (e.g., the RS for the sensing apparatus 712 or another signal for the sensing apparatus 712 or another apparatus), e.g., considering the configuration of the RS for the sensing apparatus 711.

To determine the RS configuration for the sensing apparatus 711, the network entity 600 may consider one or more factors other than signal frequency and transmission time. For example, the network entity 600 may consider an expected received power level of another signal at the sensing apparatus 711, e.g., based on the separation of the sensing apparatus 711 and the transmitter of the other signal, and the transmit power of the other signal. To determine the expected received power, the network entity 600 may also consider relative orientation of the sensing apparatus 711 and the transmitter of the other signal, and beam patterns of the sensing apparatus 711 and the transmitter of the other signal. If the expected received power level is unacceptably high (e.g., would result in unacceptably low SNR for the reference signal of the sensing apparatus 711), then the network entity 600 may determine the reference signal configuration and/or the configuration of the other signal to avoid the expected received power level being unacceptably high. If the expected received power level is not unacceptably high, then the network entity 600 may not consider this other signal when determining the configuration of the reference signal for the sensing apparatus 711. As another example, as discussed further below, to determine the configuration of the reference signal for RF sensing by the sensing apparatus 711, the network entity 600 may consider one or more reference signal measurements obtained by the sensing apparatus 711 and/or one or more parameters (determined by the sensing apparatus and/or the network entity 600) based on the one or more reference signal measurements. The network entity 600 may determine the reference signal configuration for RF sensing for the sensing apparatus 712 (and/or other sensing apparatus) in a manner similar to the determination of the reference signal configuration for RF sensing for the sensing apparatus 711.

Referring also to FIG. 11, the network entity 600 may transmit assistance data 821 (AD) to the sensing apparatus 711 and/or assistance data 822 to the sensing apparatus 712. The assistance data 821, 822 may include respective reference signal configurations and/or may include one or more instructions (e.g., as mentioned above and discussed further below) and/or reference information. For example, the assistance data 821 may include a time and frequency allocation for each of one or more reference signal resources (each corresponding to a respective beam). Thus, the network entity 600 (e.g., the processor 610) may be configured to determine a configuration of a reference signal for RF sensing by the sensing apparatus 711 and transmit the configuration of the reference signal to the sensing apparatus 711. The network entity 600 (e.g., the processor 610) may be configured to determine a configuration of another signal (e.g., a reference signal for RF sensing) for another apparatus (e.g., the sensing apparatus 712) and transmit the configuration of the other signal to the other apparatus. An AD message 1100 is an example of the assistance data 821 and includes a sensing apparatus ID field 1110, a reference signal configuration field 1120, a maximum transmission power field 1130, a transmitter location field 1140, a beam information field 1150, a maximum objects field 1160, and a coverage region field 1170. The sensing apparatus ID field 1110 indicates an identity of the sensing apparatus for which the AD message 1100 is intended. The indicated identity (here, ID711) may be a TRP ID of a base station (e.g., gNB), a UE ID, or an ID of another type of sensing apparatus. The reference signal configuration field 1120 indicates configuration parameters for the reference signal (e.g., comb number, time and frequency offsets, number of symbols, etc.). The maximum transmission power field 1130 indicates the maximum power that the sensing apparatus 711 is permitted to use to transmit the reference signal, whose configuration is provided in the reference signal configuration field 1120, for radio frequency sensing. The maximum transmission power value may be dynamic because a distance between the sensing apparatus 711 and one or more other apparatus, e.g., the sensing apparatus 712, may be dynamic. The transmitter location field 1140 may indicate the location of each of one or more transmitters, if any, that may transmit a signal (an RF sensing signal or another signal) that may interfere with (e.g., may overlap in time and frequency with) the reference signal indicated in the reference signal configuration field 1120. For example, the processor 610 may be configured to indicate, in the transmitter location field 1140, the location of the sensing apparatus 712. The location(s) may be indicated in one or more of a variety of ways (e.g., latitude and longitude values and/or an angle and a range relative to the sensing apparatus 711). The beam information field 1150 indicates the angle of arrival at the sensing apparatus 711 of the signal(s), if any, from the transmitter(s) indicated in the transmitter location field 1140 that may interfere with the reference signal indicated in the reference signal configuration field 1120. Assistance data in the fields 1140, 1150 provides reference information that may be used by the sensing apparatus 711 to determine which beam to use to transmit a reference signal for RF sensing, e.g., to reduce interference. The maximum objects field 1160 indicates the maximum quantity of objects that the sensing apparatus 711 is permitted or expected to track. The network entity 600 may determine the maximum quantity of objects for the sensing apparatus 711 to track based, for example, on the value of the maximum object quantity field 1020 of the capability message 1000. The coverage region field 1170 indicates a region in which the sensing apparatus 711 is to sense for objects using RF sensing. The region may be indicated in one or more of a variety of ways, e.g., in this example, a range of angles relative to the location of the sensing apparatus 711 expressed in terms of a global coordinate system (e.g., relative to true north). The network entity 600 may determine the coverage region for the sensing apparatus 711, 712 based on one or more factors, e.g., to avoid duplicative sensing of the same region (e.g., indicating to the sensing apparatus 711, 712 to cover different regions that do not overlap or slightly overlap instead of significantly overlapping), based on abilities of the sensing apparatus 711, 712 to sense objects in different regions, based on quantities of objects in different regions, etc. Reducing coverage overlap can reduce interference of RF sensing signals, which may improve RF sensing accuracy and/or reduce time to process RF sensing signals. The network entity 600 can combine RF sensing information for different coverage regions of different sensing apparatus to determine sensing information for a combined region. While the AD message 1100 includes a single entry, an AD message may include multiple entries, e.g., corresponding to multiple reference signal resources, each with a respective configuration and respective values of the fields 1130, 1140, 1150, 1160, 1170, although one or more values in different entries may be the same. Also or alternatively, the AD message 1100 may include multiple entries corresponding to multiple sensing apparatus.

The assistance data 821 may include information regarding nodes near the sensing apparatus 711. For example, the transmitter location field 1140 may indicate one or more transmitters that are close enough to the sensing apparatus 711 that one or more signals from the one or more transmitters may result in unacceptably high interference. For example, the network entity 600 may not include a location in the transmitter location field 1140 for any transmitter where a maximum transmission power of that transmitter, minus a path loss from the transmitter to the sensing apparatus 711, is below a threshold power (below which is acceptably low interference), i.e.,

Txₘₐₓ−path-loss<Threshold power (1)

where TXₘₐₓ is the maximum transmission power of the transmitter.

By limiting the locations included in the transmitter location field 1140 to locations of nearby nodes, signaling overhead is conserved (i.e., reduced compared to indicating locations of all neighbor transmitter nodes, e.g., in a list of neighbor TRPs).

At stage 830, the sensing apparatus 711, 712 perform mono-static RF sensing and report RF sensing results. At sub-stage 831, the sensing apparatus 711 transmits one or more reference signals for RF sensing and measures one or more reflections of the one or more transmitted reference signals. At sub-stage 832, the sensing apparatus 712 transmits one or more reference signals for RF sensing and measures one or more reflections of the one or more transmitted reference signals. The sensing apparatus 711, e.g., the RF sensing unit 550 of the sensing apparatus 711, may determine one or more measurements of one or more reference signal reflections. For example, the sensing apparatus 711 may measure received signal power and/or time of arrival. The sensing apparatus 711 may determine, based on the one or more measurements, presence of one or more objects and one or more parameters corresponding to the one or more objects. For example, the sensing apparatus may determine a range from the sensing apparatus 711 to an object (e.g., the vehicle 731), an angle from the sensing apparatus 711 to the object, direction of motion of the object, and/or speed of the object.

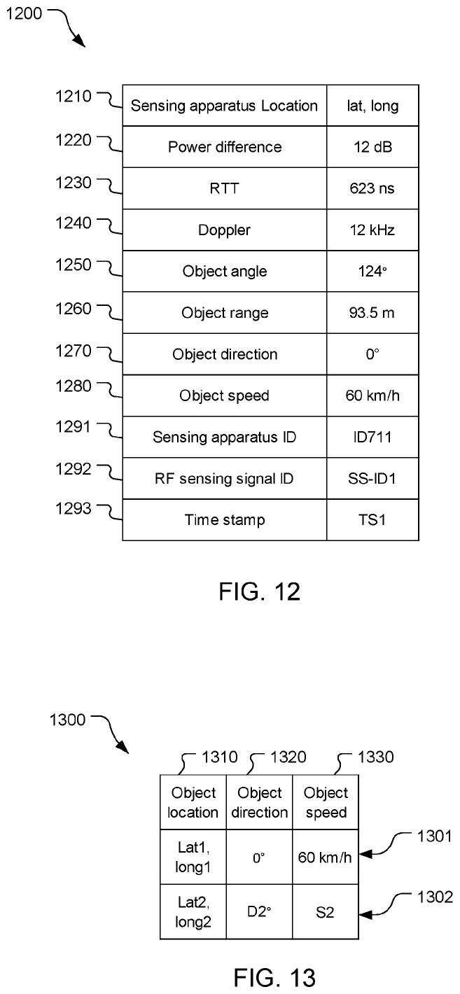

Also at stage 830, the sensing apparatus 711, 712 may determine and transmit measurement/parameter reports 833, 834, respectively, to the network entity 600. The sensing apparatus 711, 712 may transmit the measurement/parameter reports 833, 834, respectively, even if the sensing apparatus are implementing local-based mono-static RF sensing. Each of the measurement/parameter reports 833, 834 may include one or more RF sensing measurements and/or one or more parameters derived by the respective sensing apparatus 711, 712 from one or more RF sensing measurements. For example, referring also to FIG. 12, a measurement/parameter report 1200 is an example of the measurement/parameter report 833 and includes a sensing apparatus location field 1210, a power difference field 1220, a round-trip time field 1230 (RTT), a Doppler field 1240, an object angle field 1250, an object range field 1260, an object direction field 1270, an object speed field 1280, a sensing apparatus ID field 1291, an RF sensing signal ID field 1292, and a time stamp field 1293. The measurement/parameter report 1200 is an example, and other reports may be used that contain different content, e.g., contain no measurements, contain no parameters, or contain more, fewer, and/or different fields than the measurement/parameter report 1200. For example, one of the fields 1220, 1230, 1260 may be provided and the other two fields omitted from a measurement/parameter report. The sensing apparatus location field 1210 indicates a location of the sensing apparatus 711. The location may be indicated in one or more of a variety of ways, e.g., in terms of latitude and longitude. Also or alternatively, the sensing apparatus location field 1210 may be omitted or left blank and an ID of the sensing apparatus 711 indicated by the sensing apparatus ID field used by the network entity 600 to determine (e.g., look up in the memory 630) a location of the sensing apparatus 711 associated with the ID of the sensing apparatus 711. The power difference field 1220 indicates a difference (12 dB in this example) between a transmission power of a reference signal and a received power of a reflection of the reference signal by a particular object, e.g., the vehicle 732. The round-trip time field 1230 indicates a time (623 ns in this example) between transmission of the reference signal and receipt of the reflection of the reference signal. The Doppler field 1240 indicates a Doppler shift (12 kHz in this example) of the reflected reference signal relative to the transmitted reference signal. The object angle field 1250 indicates an angular direction (124° in this example) of the particular object relative to the location of the sensing apparatus 711, and may be expressed in terms of a global reference (e.g., relative to true north). The object range field 1260 indicates a distance (93.5 m in this example) between the particular object and the sensing apparatus 711. The object direction field 1270 indicates a direction of motion (0° in this example) of the particular object, e.g., relative to a global reference (e.g., relative to true north). The object speed field 1280 indicates a speed (60 km/h in this example) of the particular object. The sensing apparatus ID field 1291 indicates an ID (ID711 in this example) of the sensing apparatus 711. The RF sensing signal ID field 1292 indicates a signal ID (indicated by a variable SS-IDI in this example), e.g., a resource ID, corresponding to the sensing signal used to obtain the measurements and parameter values in the measurement/parameter report 1200. The time stamp field 1293 indicates a time (indicated by a variable TS1 in this example) corresponding to when a measurement is conducted.

At stage 840, the network entity 600 may determine object presence and may determine one or more object parameters. For example, the network entity 600 may be configured to receive one or more indications of sensing signal measurement from the sensing apparatus (e.g., in the measurement/parameter report 833), to receive one or more indications of signal measurement (e.g., sensing signal measurement) from the sensing apparatus (e.g., in the measurement/parameter report 834), and determine, based on the measurement(s), object presence and possibly one or more object parameters (e.g., speed, location, etc.).

Referring also to FIG. 13, the network entity 600 may report one or more object parameters to one or more of the sensing apparatus 711, 712. The network entity 600 may transmit a parameter report 841 to the sensing apparatus 711 and/or a parameter report 842 to the sensing apparatus 712. For example, the network entity 600 may transmit, to the sensing apparatus 711, a parameter report 1300 which is an example of the parameter report 841. The parameter report 1300 includes an object location field 1310, an object direction field 1320, and an object speed field 1330. In this example, the parameter report 1300 includes two entries 1301, 1302 corresponding to two different objects. The object location field 1310 indicates the location of the object corresponding to the respective entry 1301, 1302. The object location may be indicated in one or more of a variety of ways, e.g., in terms of latitude and longitude (as in this example), in terms of range and direction relative to the apparatus receiving the parameter report, etc. The object direction field 1320 indicates a direction of motion (0° and D2° in the entries 1301, 1302, respectively) of the respective object, e.g., relative to a global reference (e.g., relative to true north). The object speed field 1330 indicates a speed (60 km/h and S2 in the entries 1301, 1302, respectively) of the respective object. The network entity 600 may, for example, transmit the parameter report 841 to include one or more object parameters based on the measurement/parameter report 833 not including these one or more object parameters.

At stage 850, the flow 800 returns to stage 810. The network entity 600 may receive one or more of the RF sensing signal requests 811, 812 and/or one or more of the capability messages 813, 814. The network entity 600 may perform stage 820, and may use information (e.g., measurement(s) and/or parameter value(s) (e.g., object range, angle, and/or speed) from one or more of the measurement/parameter reports 833, 834 (and/or one or more measurement/parameter reports from other apparatus) to determine assistance data (e.g., signal configuration(s) and/or instruction(s)) dynamically to re-configure cross-node cooperative mono-static RF sensing. The network entity 600 may use one or more parameters provided by one or more of the sensing apparatus 711, 712 and/or one or more parameters determined by the network entity 600, e.g., from one or more measurements provided by the one or more sensing apparatus 711, 712. A parameter value provided by the sensing apparatus 711 will likely be based on measurement by the sensing apparatus 711 alone whereas a parameter value determined by the network entity 600 may be based on measurements made my multiple sensing apparatus.

At stage 820, having received one or more measurements and/or one or more parameters from one or more of the measurement/parameter reports 833, 834, the network entity 600 (e.g., the coordination unit 650) may use one or more RF sensing measurements and/or one or more object parameters to determine (or redetermine) assistance data (e.g., signal configurations) for the sensing apparatus 711 and one or more other apparatus, e.g., the sensing apparatus 712. The network entity 600 may re-configure a previous configuration (e.g., if the measurement(s) and/or parameter(s) indicate that a signal using the previous configuration experienced unacceptably high interference) or may leave a configuration alone for reuse (e.g., if the measurement(s) and/or parameter(s) indicate that a signal using the previous configuration did not experience unacceptably high interference). The network entity 600 may be configured to change a sensing signal configuration and/or a sensing apparatus for sensing a target object if one or more measurements or one or more parameters (e.g., object range, angle, and/or speed) are unreliable (e.g., below a respective threshold quality). The network entity 600 may be configured to determine that a measurement or parameter is unreliable if the measurement or parameter changes value unrealistically (e.g., speed increases faster than is realistic, a range changes unrealistically (e.g., changes by hundreds of meters in a few seconds), etc. The network entity 600 may be configured to change a periodicity of a sensing signal, e.g., to have a lower periodicity (e.g., a higher reporting frequency) in response to a speed of a target object increasing and/or a direction of the target object changing to a more sensitive direction (e.g., toward another moving object). The network entity 600, e.g., the processor 610, may be configured to receive, via the transceiver 620, one or more indications of sensing signal measurement from the sensing apparatus 711, 712 and to determine RF sensing signal configurations based on the one or more indications of sensing signal measurement. The one or more indications of sensing signal measurement may include one or more sensing signal measurement values and/or one or more object parameter values (e.g., location, speed, and/or direction of one or more target objects).

The coordination unit 650 of the network entity 600 may use one or more sensing signal measurements and/or one or more object parameters to determine assistance data in addition to or instead of signal configuration information. For example, the network entity 600 may use information from one or more of the measurement/parameter reports 833, 834 to coordinate RF sensing by the sensing apparatus 711, 712. For example, the sensing apparatus 711, 712 may be able to cover a large area of the environment 700 in combination. The network entity 600 may determine from one or more of the measurement/parameter reports 833, 834 that the sensing apparatus 711 is better suited to sense the person 740 and the sensing apparatus 712 is better suited to sense the vehicle 731 (e.g., provides more accurate, and in response indicate in the coverage region field 1170 of the AD message 1100 for the sensing apparatus 711 to cover a sector 791, and indicate in the coverage region field 1170 of an AD message for the sensing apparatus 712 to cover (over which to perform radio frequency sensing) a sector 792. Depending on the measurement and/or parameter information, the network entity 600 may redetermine a maximum quantity of objects that the sensing apparatus is permitted or expected to track such that mono-static RF sensing by multiple sensing nodes may be coordinated such that the sensing nodes cooperate to sense multiple target objects. For example, if the sensing apparatus 711 uses more than a threshold amount of time to update tracking for all tracked objects, then the network entity 600 may reduce the maximum number of objects that the sensing apparatus 711 is expected to track (or at least the maximum number of objects for which the sensing apparatus is expected to report tracking information, e.g., location, direction, speed).

The coordination unit 650 of the network entity 600 may use one or more sensing signal measurements and/or one or more object parameters to determine assistance data to coordinate mono-static RF sensing by the sensing apparatus 711, 712 (and/or other sensing apparatus). For example, the coordination unit 650 may determine a sensing signal configuration based on a reported Doppler shift of a measured sensing signal. For example, if the Doppler shift indicated in the Doppler field 1240 is high enough (e.g., greater than a subcarrier spacing of the RF sensing signal) that the RF sensing signal may bleed into another signal (e.g., a resource element of the RF sensing signal overlaps with a resource element of a signal that is adjacent in the frequency domain to the RF sensing signal), then the coordination unit 650 may reconfigure the RF sensing signal and/or the other signal to try to avoid interference caused by signal overlap. The coordination unit 650 may, for example, adjust the frequency of the RF sensing signal and/or the frequency of the other signal, or may try to avoid frequency division multiplexing the RF sensing signal and the other signal (e.g., time division multiplexing the signals instead). As another example, if a target object is close to one or more sensing apparatus, e.g., a subset of sensing apparatus, then the coordination unit 650 may assign/indicate the subset of sensing apparatus to track the target object. For example, the coordination unit 650 may instruct, e.g., using the coverage region field 1170 of the AD message 1100, the sensing apparatus 711 to track objects in a region that includes the target object. As another example, the coordination unit 650 may provide the location of the target object to the sensing apparatus 711 in the parameter report 1300 and instruct the sensing apparatus 711 to track the target object. As another example, the coordination unit 650 may change with sensing apparatus are assigned to track the target object. For example, the coordination unit 650 may determine that the target object is out, or will soon be out, of the coverage area of the sensing apparatus 711 and is in, or will be in, the coverage area of the sensing apparatus 712. In response to this determination, the coordination unit 650 may instruct the sensing apparatus 712 to track the target object. The coordination unit 650 may respond to the target object leaving the coverage area of the sensing apparatus 711 by instruction the sensing apparatus 711 to cease trying to track the target object.

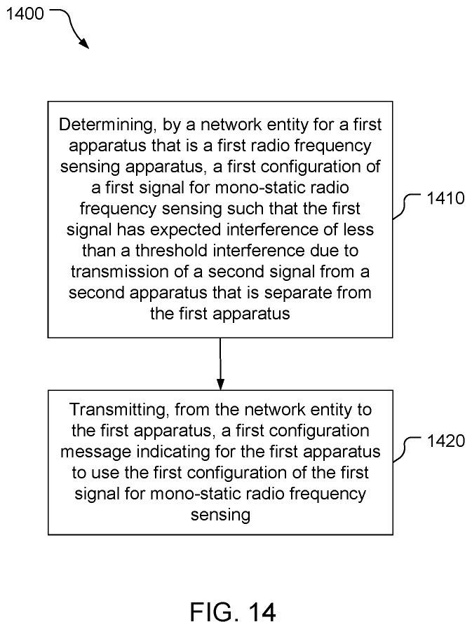

Referring to FIG. 14, with further reference to FIGS. 1-13, a mono-static radio frequency sensing coordination method 1400 includes the stages shown. The method 1400 is, however, an example and not limiting. The method 1400 may be altered, e.g., by having stages added, removed, rearranged, combined, performed concurrently, and/or having single stages split into multiple stages.

At stage 1410, the method 1400 includes determining, by a network entity for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus. For example, at stage 820 the network entity 600 determines a configuration for a first cellular network signal for RF sensing by the sensing apparatus 711 so that the signal will experience acceptably low interference (e.g., below a threshold interference, with power from one or more other signals received by the first apparatus and overlapping in time and frequency with the first cellular network signal being below a threshold power level). The network entity 600 may determine the configuration of the first cellular network signal based on information stored by the network entity 600 without receiving outside information. Alternatively, the network entity 600 may determine the configuration of the first cellular network signal based on information stored by the network entity 600, one or more requested characteristics (e.g., in the RF sensing signal request 811 and/or the RF sensing signal request 812), one or more capabilities (e.g., indicated in the capability message 813 and/or the capability message 814), one or more signal measurements (e.g., from one or both of the reports 833, 834), and/or one or more object parameters (e.g., from one or both of the reports 833, 834 and/or determined from one or more sensing signal measurements). For example, the network entity 600 (e.g., the coordination unit 650) may determine the configuration of the first cellular network signal in view of other signal configurations, may re-configure a previous configuration of the first cellular network signal, or may approve of reuse of the previous configuration of the first cellular network signal. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless receiver 344 and the antenna 346 and/or the transceiver 415 (e.g., the wired transmitter 452)) may comprise means for determining the first configuration.

At stage 1420, the method 1400 includes transmitting, from the network entity to the first apparatus, a first configuration message indicating for the first apparatus to use the first configuration of the first cellular network signal for mono-static radio frequency sensing. For example, the network entity 600 transmits the AD 821 to the sensing apparatus 711 with the AD 821 including the first configuration (e.g., in the RS configuration field 1120 of the Ad message 1100) of the first cellular network signal for mono-static radio frequency sensing. The inclusion of the first configuration may be an implicit indication for the first apparatus (here the sensing apparatus 711) to use the first configuration of the first cellular network signal for mono-static radio frequency sensing. Also or alternatively, the AD 821 may include an explicit indication to so use the first configuration. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the first configuration message.

Implementations of the method 1400 may include one or more of the following features. In an example implementation, the method 1400 includes: determining a second configuration of the second cellular network signal in conjunction with the first configuration of the first cellular network signal; and transmitting, from the network entity to the second apparatus, a second configuration message to schedule the second cellular network signal for transmission from the second apparatus. For example, at stage 820 the network entity 600 (e.g., the coordination unit 650) determines a configuration of a second cellular network signal (e.g., a reference signal dedicated for RF sensing, a signal for both communication and RF sensing, etc.) in conjunction with the first configuration. For example, the coordination unit 650 may determine the first and second configurations to avoid or reduce interference between the first and second cellular network signals (e.g., to avoid overlap in frequency and time or keep such overlap below an acceptable amount). The network entity 600 may, for example, determine time and/or frequency of the first and second cellular network signals based on a distance between the first and second apparatus (e.g., the sensing apparatus 711, 712, or the sensing apparatus 711 and another apparatus) such that an SNR of the first cellular network signal is above a threshold SNR in view of the second configuration of the second cellular network signal (e.g., the second cellular network signal being TDMed and/or FDMed with the first cellular network signal or overlapping in time and frequency with sufficiently low received power at the first apparatus). The network entity 600 may be configured to determine the second configuration using information stored in the memory 630 and/or from information received via the transceiver 620. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless receiver 344 and the antenna 346 and/or the transceiver 415 (e.g., the wired transmitter 452)) may comprise means for determining the second configuration. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the second configuration message. In a further example implementation, the second apparatus is a second radio frequency sensing apparatus, and wherein the method 1400 further includes: receiving, at the network entity from the first apparatus, one or more first indications of sensing signal measurement; receiving, at the network entity from the second apparatus, one or more second indications of sensing signal measurement; and determining, at the network entity, the first configuration and the second configuration based on the one or more first indications of sensing signal measurement and the one or more second indications of sensing signal measurement. For example, at stage 830 the network entity 600 receives one or more sensing signal measurements and/or one or more object parameter values from each of the sensing apparatus 711, 712 and uses this information at stage 820 to determine the first and second configurations of the first and second cellular network signals, e.g., to help avoid interference between the first and second cellular network signals. The processor 610 (e.g., the processor 310 and/or the processor 410), possibly in combination with the memory 630 (e.g., the memory 311 and/or the memory 411), possibly in combination with the transceiver 620 (e.g., the transceiver 315 (e.g., the wireless receiver 344 and the antenna 346 and/or the transceiver 415 (e.g., the wired transmitter 452)) may comprise means for receiving the one or more first indications of sensing signal measurements and means for receiving the one or more second indications of sensing signal measurement. The processor 610 (e.g., the processor 310 and/or the processor 410), possibly in combination with the memory 630 (e.g., the memory 311 and/or the memory 411), may comprise means for determining the first configuration and the second configuration based on the first indication(s) of sensing signal measurement and the second indication(s) of sensing signal measurement. In a further example implementation, the one or more first indications of sensing signal measurement comprise one or more measurements of a third sensing signal, one or more target parameters based on the one or more measurements of the third sensing signal, or a combination thereof. For example, the one or more first indications of sensing signal measurement may be one or more measurement values and/or one or more object parameter values based on measurement of the third sensing signal (which may be the first sensing signal or another sensing signal). In another further example implementation, the mono-static radio frequency sensing is first mono-static radio frequency sensing and the second apparatus is a second radio frequency sensing apparatus, and the method 1400 further includes: indicating to the first radio frequency sensing apparatus a first region over which to perform the first mono-static radio frequency sensing; and indicating to the second radio frequency sensing apparatus a second region over which to perform second mono-static radio frequency sensing. For example, at stage 820 the network entity 600 may instruct the sensing apparatus 711, 712 through the AD 821, 822, e.g., using the coverage region field 1170 of the AD message 1100 and/or another AD message, to perform RF sensing for respective coverage regions. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for indicating the first region to the first RF sensing apparatus and means for indicating the second region to the second RF sensing apparatus. In another further example implementation, the method 1400 includes indicating to the first radio frequency sensing apparatus a quantity of one or more target objects to track. For example, at stage 820 the network entity 600 may instruct the sensing apparatus 711 through the AD 821, e.g., using the maximum objects field 1160 of the AD message 1100, a maximum number of objects to track using RF sensing. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for indicating the quantity of one or more target objects to track.

Also or alternatively, implementations of the method 1400 may include one or more of the following features. In an example implementation, the method 1400 includes transmitting, from the network entity to the first apparatus, an indication of an angle of arrival of the second cellular network signal at the first apparatus. For example, at stage 820 the network entity 600 may inform the sensing apparatus 711 through the AD 821, e.g., using the beam information field 1150 of the AD message 1100, of an angle of arrival of the second cellular network signal (and possibly the angle(s) of arrival of one or more other signals). The sensing apparatus 711 may use this information to help avoid collision of the first cellular network signal with the second cellular network signal (e.g., to transmit the first cellular network signal using a different beam than of the angle of arrival of the second cellular network signal). The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the indication of the angle of arrival of the second cellular network signal at the first apparatus. In another example implementation, determining the first configuration of the first cellular network signal comprises determining the first configuration of the first cellular network signal based on one or more requested signal characteristics, for mono-static radio frequency sensing, received by the network entity from the first apparatus. For example, at stage 820 the coordination unit 650 may use one or more requested signal characteristics from the RF sensing signal request 811 (and possibly the RF sensing signal request 812) to determine the first configuration of the first cellular network signal. Determining the first configuration to have one or more of the one or more requested signal characteristics may help ensure adequate sensing quality, e.g., by helping avoid interference with the first cellular network signal and/or allowing the first apparatus to operate as desired to provide accurate sensing measurement.

Also or alternatively, implementations of the method 1400 may include one or more of the following features. In an example implementation, transmitting, from the network entity to the second apparatus, an indication of a maximum power for the second apparatus to use to transmit the second cellular network signal. For example, at stage 820 the network entity 600 may inform the sensing apparatus 712 through the AD 821, e.g., using a max transmit power field of the AD 822 (e.g., similar to the maximum transmission power field 1130 of the AD message 1100), of a maximum power to use to transmit the second cellular network signal. This may help avoid or reduce interference of the first cellular network signal caused by the second cellular network signal. The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the indication of maximum power for the second apparatus to use to transmit the second cellular network signal. In another example implementation, the method 1400 includes transmitting, from the network entity to the first apparatus, an indication of a location of the second apparatus. For example, at stage 820 the network entity 600 may inform the sensing apparatus 711 through the AD 821, e.g., using the transmitter location field 1140 of the AD message 1100, of an angle of arrival of the second cellular network signal (and possibly the angle(s) of a location of the second apparatus. The sensing apparatus 711 may use this information to help avoid collision of the first cellular network signal with the second cellular network signal (e.g., to transmit the first cellular network signal using a beam directed away from the location of the second apparatus). The processor 610 (e.g., the processor 310 and/or the processor 410), possibly in combination with the memory 630 (e.g., the memory 311 and/or the memory 411), in combination with the transceiver 620 (e.g., the transceiver 315 (e.g., the wireless transmitter 342 and the antenna 346) and/or the transceiver 415 (e.g., the wired transmitter 452)) may comprise means for transmitting the indication of the location of the second apparatus.

### Implementation Examples

Implementation examples are provided in the following numbered clauses.

Clause 1. A network entity comprising:
a memory;
a transceiver; and
a processor, communicatively coupled to the memory and the transceiver, configured to:
   determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
   transmit, to the first apparatus, a first configuration message indicating for the first apparatus to use the first configuration of the first cellular network signal for mono-static radio frequency sensing.

Clause 2. The network entity of clause 1, wherein the processor is configured to:
determine a second configuration of the second cellular network signal in conjunction with the first configuration of the first cellular network signal; and
transmit, via the transceiver to the second apparatus, a second configuration message to schedule the second cellular network signal for transmission from the second apparatus.

Clause 3. The network entity of clause 2, wherein the second apparatus is a second radio frequency sensing apparatus, and wherein the processor is configured to:
receive, via the transceiver from the first apparatus, one or more first indications of sensing signal measurement;
receive, via the transceiver from the second apparatus, one or more second indications of sensing signal measurement; and
determine the first configuration and the second configuration based on the one or more first indications of sensing signal measurement and the one or more second indications of sensing signal measurement.

Clause 4. The network entity of clause 3, wherein the one or more first indications of sensing signal measurement comprise one or more measurements of a third sensing signal, one or more target parameters based on the one or more measurements of the third sensing signal, or a combination thereof.

Clause 5. The network entity of clause 2, wherein the mono-static radio frequency sensing is first mono-static radio frequency sensing and the second apparatus is a second radio frequency sensing apparatus, and wherein the processor is configured to:
indicate to the first radio frequency sensing apparatus a first region over which to perform the first mono-static radio frequency sensing; and
indicate to the second radio frequency sensing apparatus a second region over which to perform second mono-static radio frequency sensing.

Clause 6. The network entity of clause 2, wherein the processor is configured to indicate to the first radio frequency sensing apparatus a quantity of one or more target objects to track.

Clause 7. The network entity of clause 1, wherein the processor is configured to transmit, via the transceiver to the first apparatus, an indication of an angle of arrival of the second cellular network signal at the first apparatus.

Clause 8. The network entity of clause 1, wherein the processor is configured to determine the first configuration of the first cellular network signal based on one or more requested signal characteristics, for mono-static radio frequency sensing, received from the first apparatus.

Clause 9. The network entity of clause 1, wherein the processor is configured to transmit, via the transceiver to the second apparatus, an indication of a maximum power for the second apparatus to use to transmit the second cellular network signal.

Clause 10. The network entity of clause 1, wherein the processor is configured to transmit, via the transceiver to the first apparatus, an indication of a location of the second apparatus.

Clause 11. A mono-static radio frequency sensing coordination method comprising:
determining, by a network entity for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
transmitting, from the network entity to the first apparatus, a first configuration message indicating for the first apparatus to use the first configuration of the first cellular network signal for mono-static radio frequency sensing.

Clause 12. The mono-static radio frequency sensing coordination method of clause 11, further comprising:
determining a second configuration of the second cellular network signal in conjunction with the first configuration of the first cellular network signal; and
transmitting, from the network entity to the second apparatus, a second configuration message to schedule the second cellular network signal for transmission from the second apparatus.

Clause 13. The mono-static radio frequency sensing coordination method of clause 12, wherein the second apparatus is a second radio frequency sensing apparatus, and wherein the mono-static radio frequency sensing coordination method further comprises:
receiving, at the network entity from the first apparatus, one or more first indications of sensing signal measurement;
receiving, at the network entity from the second apparatus, one or more second indications of sensing signal measurement; and
determining, at the network entity, the first configuration and the second configuration based on the one or more first indications of sensing signal measurement and the one or more second indications of sensing signal measurement.

Clause 14. The mono-static radio frequency sensing coordination method of clause 13, wherein the one or more first indications of sensing signal measurement comprise one or more measurements of a third sensing signal, one or more target parameters based on the one or more measurements of the third sensing signal, or a combination thereof.

Clause 15. The mono-static radio frequency sensing coordination method of clause 12, wherein the mono-static radio frequency sensing is first mono-static radio frequency sensing and the second apparatus is a second radio frequency sensing apparatus, and the mono-static radio frequency sensing coordination method further comprises:
indicating to the first radio frequency sensing apparatus a first region over which to perform the first mono-static radio frequency sensing; and
indicating to the second radio frequency sensing apparatus a second region over which to perform second mono-static radio frequency sensing.

Clause 16. The mono-static radio frequency sensing coordination method of clause 12, further comprising indicating to the first radio frequency sensing apparatus a quantity of one or more target objects to track.

Clause 17. The mono-static radio frequency sensing coordination method of clause 11, further comprising transmitting, from the network entity to the first apparatus, an indication of an angle of arrival of the second cellular network signal at the first apparatus.

Clause 18. The mono-static radio frequency sensing coordination method of clause 11, wherein determining the first configuration of the first cellular network signal comprises determining the first configuration of the first cellular network signal based on one or more requested signal characteristics, for mono-static radio frequency sensing, received by the network entity from the first apparatus.

Clause 19. The mono-static radio frequency sensing coordination method of clause 11, further comprising transmitting, from the network entity to the second apparatus, an indication of a maximum power for the second apparatus to use to transmit the second cellular network signal.

Clause 20. The mono-static radio frequency sensing coordination method of clause 11, further comprising transmitting, from the network entity to the first apparatus, an indication of a location of the second apparatus.

Clause 21. A network entity comprising:
means for determining, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
means for transmitting, to the first apparatus, a first configuration message indicating for the first apparatus to use the first configuration of the first cellular network signal for mono-static radio frequency sensing.

Clause 22. The network entity of clause 21, further comprising:
means for determining a second configuration of the second cellular network signal in conjunction with the first configuration of the first cellular network signal; and
means for transmitting, to the second apparatus, a second configuration message to schedule the second cellular network signal for transmission from the second apparatus.

Clause 23. The network entity of clause 22, wherein the second apparatus is a second radio frequency sensing apparatus, and wherein the network entity further comprises:
means for receiving, from the first apparatus, one or more first indications of sensing signal measurement;
means for receiving, from the second apparatus, one or more second indications of sensing signal measurement; and means for determining the first configuration and the second configuration based on the one or more first indications of sensing signal measurement and the one or more second indications of sensing signal measurement.

Clause 24. The network entity of clause 23, wherein the one or more first indications of sensing signal measurement comprise one or more measurements of a third sensing signal, one or more target parameters based on the one or more measurements of the third sensing signal, or a combination thereof.

Clause 25. The network entity of clause 22, wherein the mono-static radio frequency sensing is first mono-static radio frequency sensing and the second apparatus is a second radio frequency sensing apparatus, and the network entity further comprises:
means for indicating to the first radio frequency sensing apparatus a first region over which to perform the first mono-static radio frequency sensing; and
means for indicating to the second radio frequency sensing apparatus a second region over which to perform second mono-static radio frequency sensing.

Clause 26. The network entity of clause 22, further comprising means for indicating to the first radio frequency sensing apparatus a quantity of one or more target objects to track.

Clause 27. The network entity of clause 21, further comprising means for transmitting, to the first apparatus, an indication of an angle of arrival of the second cellular network signal at the first apparatus.

Clause 28. The network entity of clause 21, wherein the means for determining the first configuration of the first cellular network signal comprise means for determining the first configuration of the first cellular network signal based on one or more requested signal characteristics, for mono-static radio frequency sensing, received by the network entity from the first apparatus.

Clause 29. The network entity of clause 21, further comprising means for transmitting, to the second apparatus, an indication of a maximum power for the second apparatus to use to transmit the second cellular network signal.

Clause 30. The network entity of clause 21, further comprising means for transmitting, to the first apparatus, an indication of a location of the second apparatus.

Clause 31. A non-transitory, processor-readable storage medium comprising processor-readable instructions to cause a processor of a network entity to:
determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
transmit, to the first apparatus, a first configuration message indicating for the first apparatus to use the first configuration of the first cellular network signal for mono-static radio frequency sensing.

Clause 32. The non-transitory, processor-readable storage medium of clause 31, further comprising processor-readable instructions to cause the processor to:
determine a second configuration of the second cellular network signal in conjunction with the first configuration of the first cellular network signal; and
transmit, to the second apparatus, a second configuration message to schedule the second cellular network signal for transmission from the second apparatus.

Clause 33. The non-transitory, processor-readable storage medium of clause 32, wherein the second apparatus is a second radio frequency sensing apparatus, and wherein the non-transitory, processor-readable storage medium further comprises processor-readable instructions to cause the processor to:
receive, from the first apparatus, one or more first indications of sensing signal measurement;
receive, from the second apparatus, one or more second indications of sensing signal measurement; and
determine the first configuration and the second configuration based on the one or more first indications of sensing signal measurement and the one or more second indications of sensing signal measurement.

Clause 34. The non-transitory, processor-readable storage medium of clause 33, wherein the one or more first indications of sensing signal measurement comprise one or more measurements of a third sensing signal, one or more target parameters based on the one or more measurements of the third sensing signal, or a combination thereof.

Clause 35. The non-transitory, processor-readable storage medium of clause 32, wherein the mono-static radio frequency sensing is first mono-static radio frequency sensing and the second apparatus is a second radio frequency sensing apparatus, and the non-transitory, processor-readable storage medium further comprises processor-readable instructions to cause the processor to:
indicate to the first radio frequency sensing apparatus a first region over which to perform the first mono-static radio frequency sensing; and
indicate to the second radio frequency sensing apparatus a second region over which to perform second mono-static radio frequency sensing.

Clause 36. The non-transitory, processor-readable storage medium of clause 32, further comprising processor-readable instructions to cause the processor to indicate to the first radio frequency sensing apparatus a quantity of one or more target objects to track.

Clause 37. The non-transitory, processor-readable storage medium of clause 31, further comprising processor-readable instructions to cause the processor to transmit, to the first apparatus, an indication of an angle of arrival of the second cellular network signal at the first apparatus.

Clause 38. The non-transitory, processor-readable storage medium of clause 31, wherein the processor-readable instructions to cause the processor to determine the first configuration of the first cellular network signal comprise processor-readable instructions to cause the processor to determine the first configuration of the first cellular network signal based on one or more requested signal characteristics, for mono-static radio frequency sensing, received by the network entity from the first apparatus.

Clause 39. The non-transitory, processor-readable storage medium of clause 31, further comprising processor-readable instructions to cause the processor to transmit, to the second apparatus, an indication of a maximum power for the second apparatus to use to transmit the second cellular network signal.

Clause 40. The non-transitory, processor-readable storage medium of clause 31, further comprising processor-readable instructions to cause the processor to transmit, to the first apparatus, an indication of a location of the second apparatus.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A network entity comprising:
a memory;
a transceiver; and
a processor, communicatively coupled to the memory and the transceiver, configured to:
determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
transmit, to the first apparatus, a first configuration message indicating for the first apparatus to use the first configuration of the first cellular network signal for mono-static radio frequency sensing.

2. The network entity of claim 1, wherein the processor is configured to:
determine a second configuration of the second cellular network signal in conjunction with the first configuration of the first cellular network signal; and
transmit, via the transceiver to the second apparatus, a second configuration message to schedule the second cellular network signal for transmission from the second apparatus.

3. The network entity of claim 2, wherein the second apparatus is a second radio frequency sensing apparatus, and wherein the processor is configured to:
receive, via the transceiver from the first apparatus, one or more first indications of sensing signal measurement;
receive, via the transceiver from the second apparatus, one or more second indications of sensing signal measurement; and
determine the first configuration and the second configuration based on the one or more first indications of sensing signal measurement and the one or more second indications of sensing signal measurement.

4. The network entity of claim 3, wherein the one or more first indications of sensing signal measurement comprise one or more measurements of a third sensing signal, one or more target parameters based on the one or more measurements of the third sensing signal, or a combination thereof.

5. The network entity of claim 2, wherein the mono-static radio frequency sensing is first mono-static radio frequency sensing and the second apparatus is a second radio frequency sensing apparatus, and wherein the processor is configured to:
indicate to the first radio frequency sensing apparatus a first region over which to perform the first mono-static radio frequency sensing; and
indicate to the second radio frequency sensing apparatus a second region over which to perform second mono-static radio frequency sensing.

6. The network entity of claim 2, wherein the processor is configured to indicate to the first radio frequency sensing apparatus a quantity of one or more target objects to track.

7. The network entity of claim 1, wherein the processor is configured to transmit, via the transceiver to the first apparatus, an indication of an angle of arrival of the second cellular network signal at the first apparatus.

8. The network entity of claim 1, wherein the processor is configured to determine the first configuration of the first cellular network signal based on one or more requested signal characteristics, for mono-static radio frequency sensing, received from the first apparatus.

9. The network entity of claim 1, wherein the processor is configured to transmit, via the transceiver to the second apparatus, an indication of a maximum power for the second apparatus to use to transmit the second cellular network signal.

10. The network entity of claim 1, wherein the processor is configured to transmit, via the transceiver to the first apparatus, an indication of a location of the second apparatus.

11. A mono-static radio frequency sensing coordination method comprising:
determining, by a network entity for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
transmitting, from the network entity to the first apparatus, a first configuration message indicating for the first apparatus to use the first configuration of the first cellular network signal for mono-static radio frequency sensing.

12. The mono-static radio frequency sensing coordination method of claim 11, further comprising:
determining a second configuration of the second cellular network signal in conjunction with the first configuration of the first cellular network signal; and
transmitting, from the network entity to the second apparatus, a second configuration message to schedule the second cellular network signal for transmission from the second apparatus.

13. The mono-static radio frequency sensing coordination method of claim 12, wherein the second apparatus is a second radio frequency sensing apparatus, and wherein the mono-static radio frequency sensing coordination method further comprises:
receiving, at the network entity from the first apparatus, one or more first indications of sensing signal measurement;
receiving, at the network entity from the second apparatus, one or more second indications of sensing signal measurement; and
determining, at the network entity, the first configuration and the second configuration based on the one or more first indications of sensing signal measurement and the one or more second indications of sensing signal measurement.

14. The mono-static radio frequency sensing coordination method of claim 13, wherein the one or more first indications of sensing signal measurement comprise one or more measurements of a third sensing signal, one or more target parameters based on the one or more measurements of the third sensing signal, or a combination thereof.

15. The mono-static radio frequency sensing coordination method of claim 12, wherein the mono-static radio frequency sensing is first mono-static radio frequency sensing and the second apparatus is a second radio frequency sensing apparatus, and the mono-static radio frequency sensing coordination method further comprises:
indicating to the first radio frequency sensing apparatus a first region over which to perform the first mono-static radio frequency sensing; and
indicating to the second radio frequency sensing apparatus a second region over which to perform second mono-static radio frequency sensing.

16. The mono-static radio frequency sensing coordination method of claim 12, further comprising indicating to the first radio frequency sensing apparatus a quantity of one or more target objects to track.

17. The mono-static radio frequency sensing coordination method of claim 11, further comprising transmitting, from the network entity to the first apparatus, an indication of an angle of arrival of the second cellular network signal at the first apparatus.

18. The mono-static radio frequency sensing coordination method of claim 11, wherein determining the first configuration of the first cellular network signal comprises determining the first configuration of the first cellular network signal based on one or more requested signal characteristics, for mono-static radio frequency sensing, received by the network entity from the first apparatus.

19. The mono-static radio frequency sensing coordination method of claim 11, further comprising transmitting, from the network entity to the second apparatus, an indication of a maximum power for the second apparatus to use to transmit the second cellular network signal.

20. The mono-static radio frequency sensing coordination method of claim 11, further comprising transmitting, from the network entity to the first apparatus, an indication of a location of the second apparatus.

21. A network entity comprising:
means for determining, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
means for transmitting, to the first apparatus, a first configuration message indicating for the first apparatus to use the first configuration of the first cellular network signal for mono-static radio frequency sensing.

22. The network entity of claim 21, further comprising:
means for determining a second configuration of the second cellular network signal in conjunction with the first configuration of the first cellular network signal; and
means for transmitting, to the second apparatus, a second configuration message to schedule the second cellular network signal for transmission from the second apparatus.

23. The network entity of claim 22, wherein the second apparatus is a second radio frequency sensing apparatus, and wherein the network entity further comprises:
means for receiving, from the first apparatus, one or more first indications of sensing signal measurement;
means for receiving, from the second apparatus, one or more second indications of sensing signal measurement; and
means for determining the first configuration and the second configuration based on the one or more first indications of sensing signal measurement and the one or more second indications of sensing signal measurement.

24. The network entity of claim 23, wherein the one or more first indications of sensing signal measurement comprise one or more measurements of a third sensing signal, one or more target parameters based on the one or more measurements of the third sensing signal, or a combination thereof.

25. The network entity of claim 22, wherein the mono-static radio frequency sensing is first mono-static radio frequency sensing and the second apparatus is a second radio frequency sensing apparatus, and the network entity further comprises:
means for indicating to the first radio frequency sensing apparatus a first region over which to perform the first mono-static radio frequency sensing; and
means for indicating to the second radio frequency sensing apparatus a second region over which to perform second mono-static radio frequency sensing.

26. The network entity of claim 22, further comprising means for indicating to the first radio frequency sensing apparatus a quantity of one or more target objects to track.

27. The network entity of claim 21, further comprising means for transmitting, to the first apparatus, an indication of an angle of arrival of the second cellular network signal at the first apparatus.

28. The network entity of claim 21, wherein the means for determining the first configuration of the first cellular network signal comprise means for determining the first configuration of the first cellular network signal based on one or more requested signal characteristics, for mono-static radio frequency sensing, received by the network entity from the first apparatus.

29. The network entity of claim 21, further comprising means for transmitting, to the second apparatus, an indication of a maximum power for the second apparatus to use to transmit the second cellular network signal.

30. A non-transitory, processor-readable storage medium comprising processor-readable instructions to cause a processor of a network entity to:
determine, for a first apparatus that is a first radio frequency sensing apparatus, a first configuration of a first cellular network signal for mono-static radio frequency sensing such that the first cellular network signal has expected interference of less than a threshold interference due to transmission of a second cellular network signal from a second apparatus that is separate from the first apparatus; and
transmit, to the first apparatus, a first configuration message indicating for the first apparatus to use the first configuration of the first cellular network signal for mono-static radio frequency sensing.
